(19) United States
(12) Patent Application Publication
(10) Pub. No.: US 2005/0263571 A1
(43) Pub. Date: Dec. 1, 2005

(54) Injection molded continuously solidified solder method and apparatus

(76) Inventors: Luc Belanger, Canton de Granby (CA); Guy Brouillette, Canton de Shefford (CA); Stephen L. Buchwalter, Hopewell Junction, NY (US); Peter A. Gruber, Mohegan Lake, NY (US); Hideo Kimura, Otsu City (JP); Jean-Luc Landreville, Canto de Granby (CA); Frederic Manurer, Valhalla, NY (US); Marc Montminy, Canton de Granby (CA); Valerie Oberson, St-Alphonse de Granby (CA); Da-Yuan Shih, Poughkeepsie, NY (US); Stephane St-Onge, Canton de Granby (CA); Michel Turgeon, Canton de Granby (CA); Takeshi Yamada, Kusatsu (JP)

Correspondence Address: David Aker, 23 Southern Road, Hartsdale, NY, 10530, US

(21) Appl. No.: 10/857,988

(22) Filed: May 30, 2004

(51) Int. Cl. B23K 31/02

(52) U.S. Cl. 228/256; 228/46

(57) ABSTRACT

A method and apparatus for forming solder bumps by molten solder deposition into cavity arrays in a substrate immediately followed by solidification of molten solder such that precise replication of cavity volumes is consistently achieved in formed solder bump arrays. Various solder filling problems, such as those caused by surface tension and oxidation effects, are overcome by a combination of narrow molten Solder dispense slots and solidification of dispensed molten solder.

### FIELD OF THE INVENTION

This invention relates to the field of solder interconnects formed between silicon circuit devices and substrates forming the next layer of electrical interconnect. More specifically, the invention relates to improvements in injection molded solder technologies used to form solder bump interconnections on silicon wafers.

### BACKGROUND OF THE INVENTION

Injection Molded Soldering (IMS) is a new process with many applications, primarily suited for low-cost solder bumping of semiconductor wafers. It basically involves scanning a head which dispenses molten solder through a linear slot over a mold plate to fill cavities therein with molten solder. After the scan, the solder in the cavities is solidified and then the mold plate is aligned to and placed in contact with a wafer by an appropriate fixture. This assembly is then heated to re-flow and transfer the solder from the mold plate cavities to metallized pads on the wafer. After cooling and separating the wafer and mold plate, the wafer is bumped with solder preforms typically used for flip chip applications.

U.S. Pat. No. 6,056,191 entitled ‘Method and Apparatus for Forming Solder Bumps”, while being a significant advance in the art, may in certain applications exhibit, three problems with the IMS process as practiced presently. These problems having to do with molten solder exiting behind the scanning head.

Typically, an atmosphere of only 1-2% or less oxygen is maintained in the chamber where the head scans over mold plates in order to reduce oxidation of either lead or lead-free solder alloys.

Referring to FIG. 1, a prior art IMS head 20, having a solder reservoir 22, and a die or contact plate 24, with a solder injection slot 26 is used to deposit solder 28 in the cavities 30 of a mold plate 32. The head 20 scans in the direction represented by arrow 34.

Referring to FIG. 2, the first problem is that at oxygen levels much lower than 1-2%, the molten solder in cavities exiting behind the fill head will actually ball-up, meaning the solder volume changes in shape from the hemispherical cavity to a full sphere 36 with reduced surface area in contact with the cavity walls. On solidification, these solder balls are thus easily dislocated from the cavities before the transfer step, making the process bump yield unacceptable.

Referring to FIG. 3, the second problem is that at oxygen levels where ball-up does not occur due to an oxide skin immediately forming over the tops of solder filled cavities exiting behind the contact plate 24 of the scanning fill head, these levels also produce residual oxidation debris 38 over the entire surface of the mold plate 32 and on the trailing edge 39 of the fill head. This oxide contamination must subsequently be removed from the surface of the mold plate 32 after cooling and also from the trailing edge 39 of the contact plate 24 of the head 20 after a relatively small number of molds have been scanned and solder filled. Thus, this second problem adds costly process and maintenance steps to IMS wafer bump manufacturing, imperiling the low-cost attribute of the process.

The third problem is associated with surface tension induced fill non-uniformities typically caused by the trailing edge 39 of the contact plate 24. As seen in FIG. 4, these sometimes result in solder bridging 40 and incomplete fills 42 which adversely affect yields. Solder bridging 40 is removed before the mold plate is transferred to the wafer, but this adds process costs and steps.

The only solution to the first problem has been to keep the process oxygen at levels that prevent ball-up, which as mentioned previously causes the second and third problems. These then require another solution using a post-fill step called “solder shaving”. This solves problems two and three, but adds other problems, namely extra process steps and mechanical damage to mold plates. “Shaving” involves sharp metal blades sliding across the mold plate top surface to remove excess solder and solder oxides remaining due to higher oxygen levels to prevent ball-up. If the mold plates are glass, this shaving step reduces mold plate lifetimes. If the mold plates are glass with coated polyimide containing the cavities, then this is not possible since it will damage the softer polyimide material. Thus, all these solutions are unsatisfactory from a manufacturing standpoint.

### SUMMARY OF THE INVENTION

It is therefore an aspect of the present invention to provide a method and an apparatus for the accurate deposition of solder in cavities in a substrate, including complete filling of the cavities.

It is another aspect of this invention to provide a method and apparatus which fills such cavities without leaving debris that must be removed in a separate process.

It is yet another aspect of this invention to provide a substrate that has cavities in a surface of the substrate that have been filled with solder which has been solidified so as to accurately and completely fill the cavities.

A satisfactory solution to all these problems is to solidify the solder before it exists the trailing edge of the scanning IMS fill head. This solves the first problem in that solidified solder in cavities can no longer ball-up, regardless of how low oxygen levels are. It will also solve the second problem by allowing far lower oxygen levels to be used, which will all but eliminate excessive oxidation from contaminating either the mold plate surface or the head. The third problem of fill non-uniformities due to incomplete fill and solder bridging is also eliminated due to a) a new narrow slot geometry assuring optimized fill and b) solidification taking place while the constraining surface of the scanning head is still over the filled cavities, thus assuring fill levels coplanar with the top surface of the cavities.

This novel solution has the advantage over the “shaving” solution in that 1) no extra processing steps are required and 2) no mechanical damage can occur to the mold plate. Additionally, this solution allows the use of polyimide-on-glass mold plates in the same manner as etched glass mold plates, since no mechanical “shaving” is required that would quickly damage the softer polyimide layer. For these and other reasons, the present invention is the ideal solution to making the new IMS process truly manufacturable.

Thus, the invention is directed a method for filling solder in a multiplicity of cavities on the surface of a substrate, comprising providing a stream of molten solder through a slot opening in a die that traverses the substrate so as to place successive ones of the multiplicity of cavities in intimate contact with the slot opening, the contact being such that the molten solder in the stream exerts a pressure against the surface of the substrate so as to fill the multiplicity of cavities with molten solder, and successively solidifying the molten solder in the cavities immediately after the cavities are filled with solder. The solder is constrained by the die when solidifying. Preferably the solidifying is performed by successively cooling the solder in the cavities. The cooling may be performed by using a cooled solidification zone immediately following the die.

The method may be used when the substrate is that of a bump solder mold, a semiconductor device, or an electrical interconnection device. Advantageously, the method is conducted in an atmosphere having an oxygen concentration of between one and two percent by volume, or less than one percent by volume.

A plurality of the substrate may be mounted on a moving belt, and the head scanned with respect to the substrates due to motion of the belt. A heating zone, a rapid cooling region, and a residual cooling region may be positioned on an opposite side of the belt from the substrates and the head, and the substrates may be moved through the heating zone, the rapid cooling region, and the residual cooling region.

The method may further comprise placing the substrate on a hot plate heated to below the melting point of the solder; heating the substrate to a temperature greater than that of the melting point of the solder; moving the hot plate so that the surface of the substrate is scanned by the head; and withdrawing the hot plate from the head. The heating of the substrate and the moving are thus performed simultaneously. Successive hot plates traveling in an endless loop may carry successive substrates to be scanned by the head. Radiative heating is used for heating the substrate to a temperature greater than that of the melting point of the solder.

The solder is applied through a slot having a width of approximately 0.0005 inch (0.0125 mm) to approximately 0.010 inch (0.25 mm). The slot may thus have a length to width ratio between 24,000 to 1 and 1,000 to 1.

The method may further comprise providing additional molten solder through at least one additional slot opening in the die, to fill any unfilled regions of the cavities. The at least one additional slot consists of two additional slots, so that there are a total of three slots.

The invention is also directed to a method for filling solder in a multiplicity of cavities on the surface of a substrate, comprising providing a stream of molten solder through a slot opening in a die, that traverses the substrate so as to place successive ones of the multiplicity of cavities in intimate contact with the slot opening, the contact being such that the molten solder in the stream exerts a pressure against the surface of the substrate so as to fill the multiplicity of cavities with molten solder, and solidifying the molten solder in the cavities, wherein the slot opening has a width of between approximately 0.0005 inch (0.0125 mm) and approximately 0.010 inch (0.25 mm). The a slot may have the above mentioned a length to width ratio between 24,000 to 1 and 1,000 to 1.

The invention is further directed to an apparatus for filling solder in a multiplicity of cavities on the surface of a substrate, comprising a source of a stream of molten solder; a die having a slot opening through which the molten solder flows; an arrangement for causing relative motion between the substrate and the die so that the die traverses the substrate so as to place successive ones of the multiplicity of cavities in intimate contact with the slot opening, the contact being such that the molten solder in the stream exerts a pressure against the surface of the substrate so as to fill the multiplicity of cavities with molten solder; and a cooling portion associated with the die and positioned to successively solidifying the molten solder in the cavities immediately after the cavities are filled with solder while constrained vertically by the die. The cooling portion may be a cooled solidification zone positioned so as to immediately follow the die in contacting and vertically constraining solder in the openings.

The apparatus may be configured to receive as the substrate, a bump solder mold,, a semiconductor device or an electrical interconnection device, such as for example a chip carrier.

Preferably, the apparatus further comprises an atmosphere control portion for providing a controlled atmosphere in which the filling of the cavities occurs. The atmosphere control portion may provide an atmosphere having an oxygen concentration of between one and two percent by volume, or less than one percent by volume.

The apparatus may further comprise a moving belt for receiving a plurality of the substrate, and wherein the head is scanned with respect to the substrates due to motion of the belt.

The apparatus may further comprise a heating zone, a rapid cooling region, and a residual cooling region in a position on an opposite side of the belt from the substrates and the head, so that the substrates are moved through the heating zone, the rapid cooling region, and the residual cooling region. Preferably, the heating zone is aligned with the die, and the rapid cooling region is aligned with the cooling portion on opposite sides of the belt.

The apparatus may further comprise a hot plate heated to below the melting point of the solder for receiving the substrate; a heater for heating the substrate to a temperature greater than that of the melting point of the solder; an arrangement for moving the hot plate so that the surface of the substrate is scanned by the head; and for then withdrawing the hot plate from the head. The heating of the substrate and the moving may be performed simultaneously. The apparatus may further comprise an arrangement for transporting successive hot plates in an endless loop to be scanned by the head.

The apparatus may further comprise a radiative heater for heating the substrate to a temperature greater than that of the melting point of the solder. The slot may have a width and a length to width ratio, as mentioned above.

The apparatus may further comprise at least one additional slot opening in the die, for providing additional molten solder to fill any unfilled regions of the cavities. A total of three slots may be used.

The invention is also directed to an apparatus for filling solder in a multiplicity of cavities on the surface of a substrate, comprising a source of a stream of molten solder; a die having a slot opening through which the molten solder flows; an arrangement for causing relative motion between the substrate and the die so that the die traverses the substrate so as to place successive ones of the multiplicity of cavities in intimate contact with the slot opening, the contact being such that the molten solder in the stream exerts a pressure against the surface of the substrate so as to fill the multiplicity of cavities with molten solder; and wherein the slot opening has a width of between approximately 0.0005 inch (0.0125 mm) and approximately 0.010 inch (0.25 mm). The slot may have a length to width ratio between 24,000 to 1 and 1,000 to 1.

The invention is also directed to an article of manufacture comprising a substrate having cavities on a surface, the cavities being filled with solidified solder; and the solder having been solidified in each cavity in a direction parallel to the surface. The solder is constrained at the surface as the solder solidified.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 is an enlarged, cross sectional schematic view of a prior art IMS apparatus. FIG. 2 shows the IMS head of FIG. 1 causing “ball-up” of solder in a mold cavity.

FIG. 3 shows the IMS head of FIG. 1 trailing residual solder oxide debris.

FIG. 4 shows the IMS head of FIG. 1 causing solder bridging between filled cavities.

FIG. 5 is an enlarged, cross sectional schematic view of an IMS apparatus including a solidification zone, in accordance with a first embodiment of the invention.

FIG. 5A is a further enlarged, cross sectional schematic view of an IMS apparatus including a solidification zone and multiple solder slots, in accordance with a variation of the embodiment of the invention of FIG. 5.

FIG. 6 shows the apparatus of FIG. 5 used with a mold plate transport belt and heating and cooling zones, in accordance with the first embodiment of the invention.

FIG. 7 illustrates a second embodiment of an IMS apparatus in accordance with the invention.

FIG. 8A illustrates the wide solder slot geometry of prior art IMS heads.

FIG. 8B is a photograph which illustrates the poor results achieved by using wide solder slot geometry of prior art IMS heads.

FIG. 8C illustrates the narrow solder slot geometry of IMS heads in accordance with the invention.

FIG. 8D is a photograph which illustrates the resulting cavity solder fill improvements by using the solder slot geometry of IMS heads in accordance with the invention.

FIG. 9A, FIG. 9B and FIG. 9C illustrate the solder filling problems with older IMS head technology.

FIG. 10A, FIG. 10B and FIG. 10C illustrate solder filling improvements using the IMCSS head technology in accordance with the invention.

### DESCRIPTION OF THE INVENTION

Variations described for the present invention can be realized in any combination desirable for each particular application. Thus particular limitations, and/or embodiment enhancements described herein, which may have particular advantages to the particular application need not be used for all applications. Also, it should be realized that not all limitations need be implemented in methods, systems and/or apparatus including one or more concepts of the present invention.

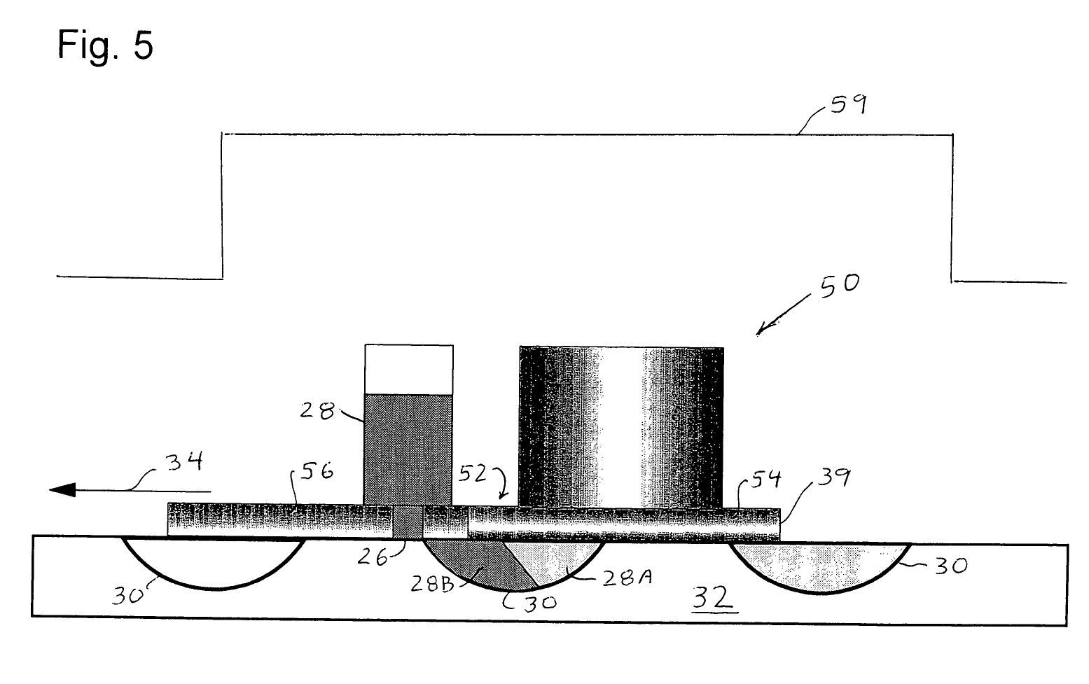

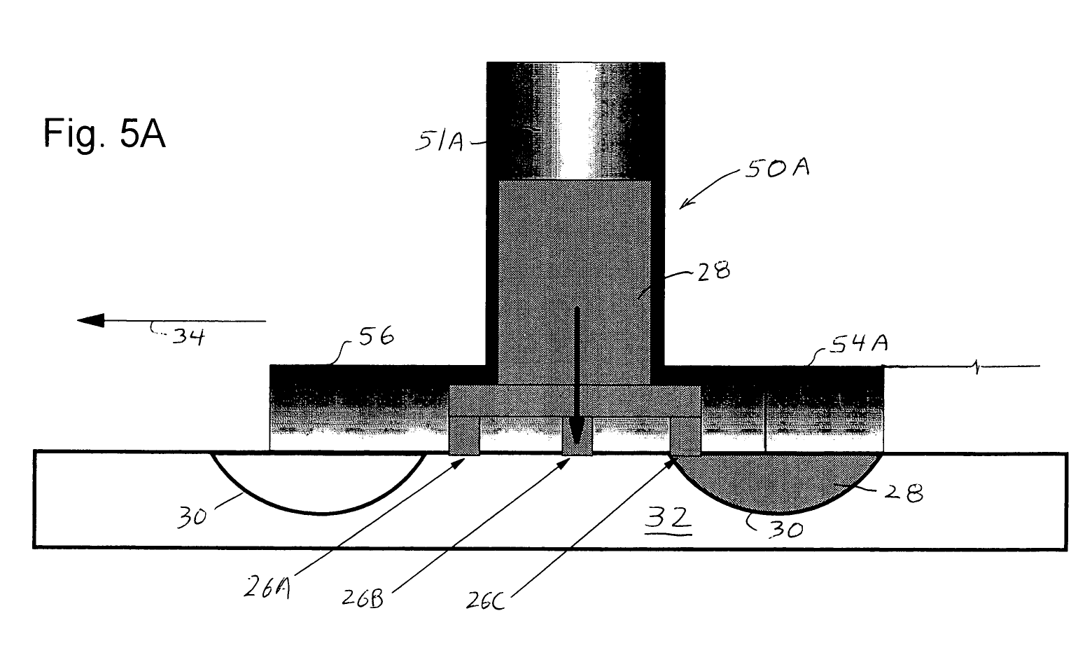

Referring to FIG. 5, a key feature of this invention is an IMS head 50 with a generally longer die or contact plate 52 which includes a cooling zone 54 after the hot solder injection zone 56. The solder 28, from reservoir 51, solidifies across each cavity in the mold plate 32 in the direction of the scan, as represented by arrow 34, and by solidified solder 28A and still molten solder 28B, with the solidification taking place as molten solder comes into contact with cooling zone 54 of contact plate 52. This may or may not be combined with additional cooling of mold plates 32 to achieve solidification of the molten solder in the cavities 30 before the constraining surface of the contact plate 52 of the head 50 moves away. Thus, a much more precise filling occurs since the solder will exactly replicate the volume of the cavity in the mold plate with a flat top coplanar to the mold plate surface. Several additional key advantages are immediately apparent. Whereas previously cavity aspect ratios needed to be about one half depth to width, the cavities can be shallower when solidification occurs. This is because surface tension induced defects caused by the fill head trailing edge 39 no longer occur if the solder exiting the head is already solidified. Thus, molded solder features possible with this new “IMCSS Process” (Injection Molded Continuously Solidified Solder Process) include a much greater variety of shapes and aspect ratios, which in addition to traditional uses, may allow completely new applications than possible without solidification.

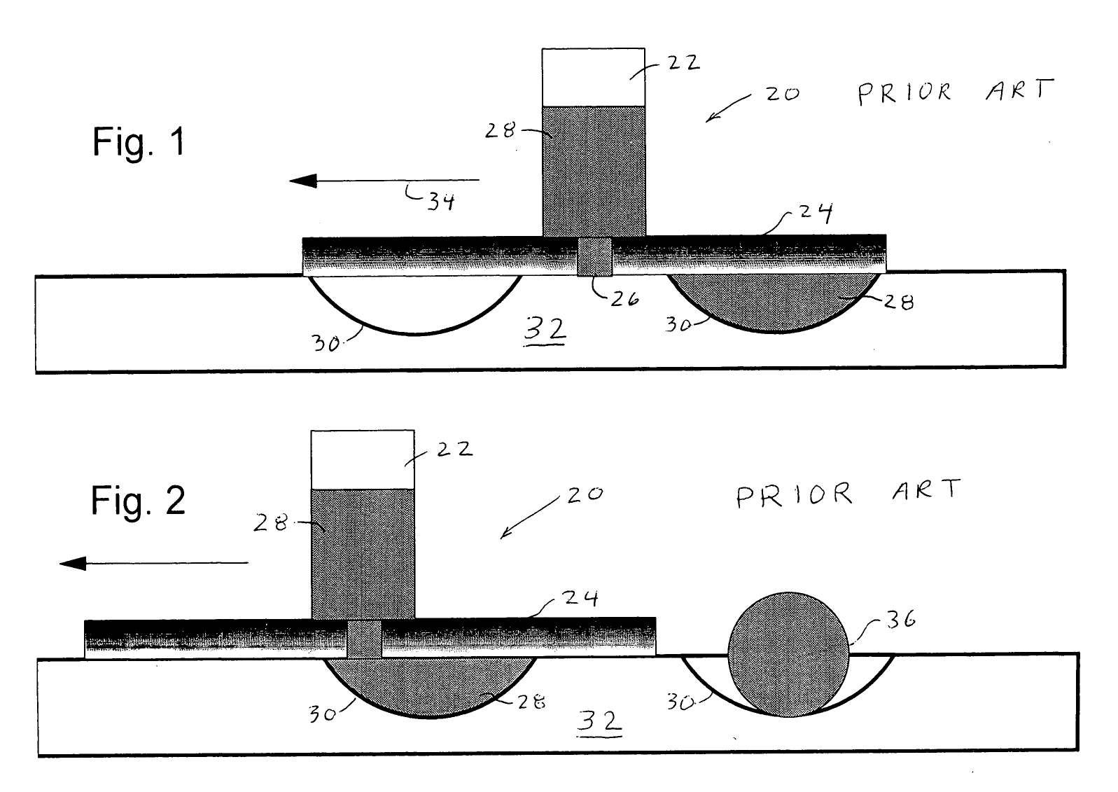

Comparing FIG. 5 to FIGS. 1-4, the novel head changes that makes the IMCSS process work becomes apparent. First, the filling now takes place in a very low oxygen environment, which may be one to two percent by volume oxygen, but can be under one percent by volume oxygen. However, unlike the ball-up problem shown in FIG. 2 due to surface tension, FIG. 5 has no ball-up on the filled cavity appearing behind the head. This is due to the fact that the solder is already solidified when exiting the head trailing edge 39 of the contact plate 52.

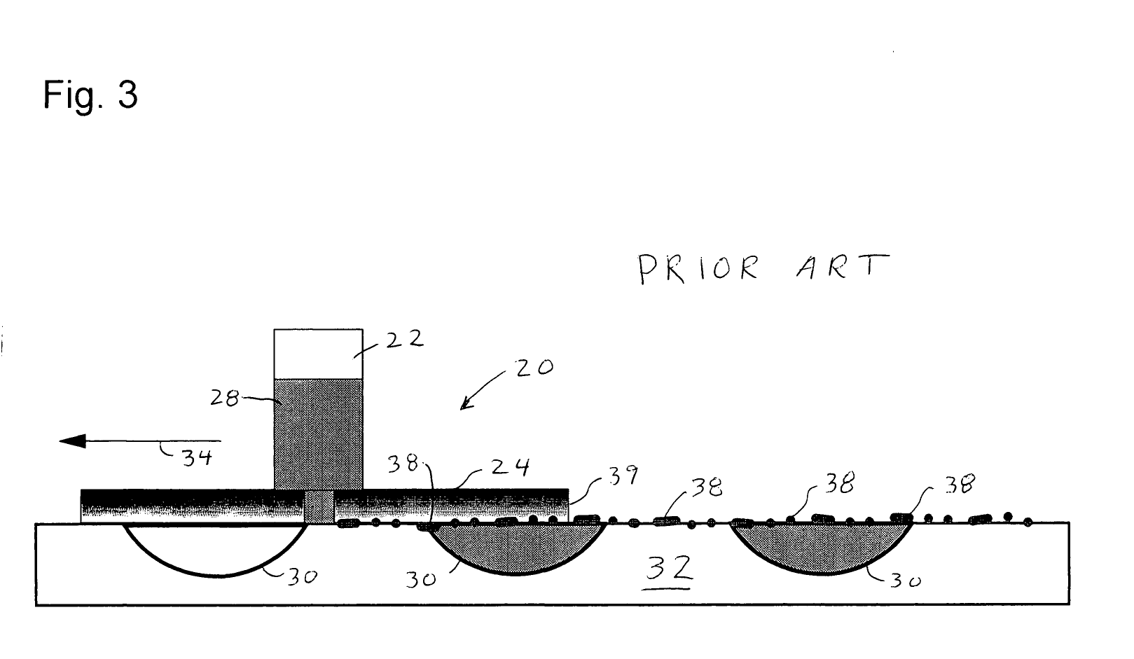

The apparatus of FIG. 5 also solves the problem shown in FIG. 3 where the filling takes place in only a reduced oxygen, not a very low oxygen environment. FIG. 5 shows no oxide debris forming either on the surface of the mold plate 32 or on the bottom of the contact plate 52 of head 50 after the solder injection slot 26 which dispenses molten solder 28. This means that the subsequent “shaving” step to remove the residual solder oxide debris is also eliminated. This assures that even polyimide on glass mold plates can be used successfully since no potentially damaging mechanical processes are used after the fill process done by the scan of head 50, and the mold plates may be reused many times. The process in accordance with the invention solves the residual oxide problem by allowing the solidification to prevent ball-up, rather than by using an oxide skin. Thus, very low oxygen levels are used which prevent the excessive oxidation shown and described for FIG. 3.

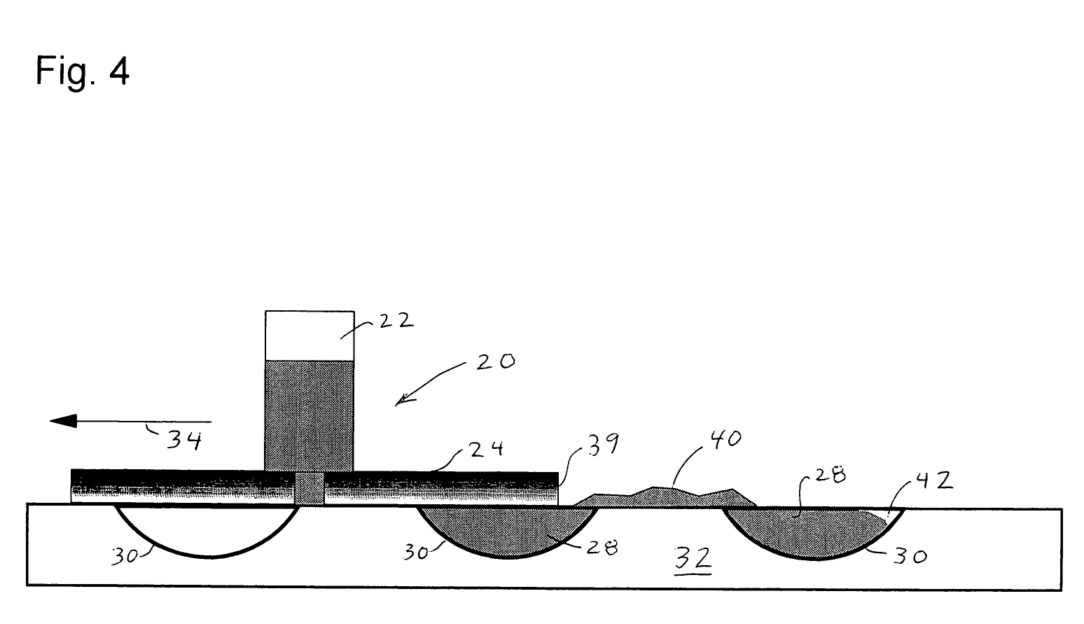

The embodiment of FIG. 5 solves the problem shown in FIG. 4 through solidification as well. Solder bridging may result when surface tension effects caused by the trailing edge 39 of contact plate 52 drag solder from the cavity volume out to the surface of the mold plate 32. This causes two problems, namely incomplete fills of the cavities themselves and solder where it does not belong—on the top surface of the mold plate 32. Since use of the process in accordance with the present invention already solidifies the solder in the cavities before these emerge behind the head, the trailing edge cannot affect the solder in the cavities. Thus, both bridging 40 and incomplete fills 42 (FIG. 4) are avoided.

As noted above with respect to FIG. 5, when the longer contact plate 52 of IMCSS head 50 scans over successive rows of cavities 30 in the mold plate 32, cooling zone 54 immediately follows the hot solder injection zone 56 of the head 50. Depending on the temperature difference between the two zones, these may either share the same base sheet or be two different sheets having a closely fitted abutting contact. The latter is required if the temperature difference between zones would cause sheet warpage at the hot/cold interface due to the coefficient of thermal expansion of the sheet material. A typical material for the contact plate 52 of IMCSS head 50 that is in sliding contact with the mold plates 32 is 301 stainless spring steel, having a thickness in the range of 0.020 to 0.025 inch (0.51 mm to 0.64 mm), with a 46 Rockwell C hardness and coated to decrease the friction coefficient. Coatings may include a number of materials such as nitride or Teflon (TM), coating only the surface and having a thickness in the range of 0.001-0.020″ or impregnated by various means. A technology used to accomplish this is available from General Magnaplate Corporation of Linden, N.J., United States of America and is described on its web site (See http://www.magnaplate.com/solutions/work.html).

The cooling zone may be cooled by nitrogen, air or water, although gas cooling typically provides sufficient capacity, because a change in temperature of only 15-25° C. is required. Apparatus for performing cooling may also be found in U.S. Pat. No. 5,388,635, entitled Compliant Fluidic Cooling Hat, assigned to the same assignee as that of the present invention.

The apparatus of FIG. 5, or of any embodiment of the invention, is preferably enclosed in an atmospheric control chamber 59, so as to control the oxygen content, for the reasons explained herein. This may be accomplished using a sealed environment, or by simply flooding the work area with a relatively non-reactive gas such as nitrogen, which may be suitably vented to the atmosphere.

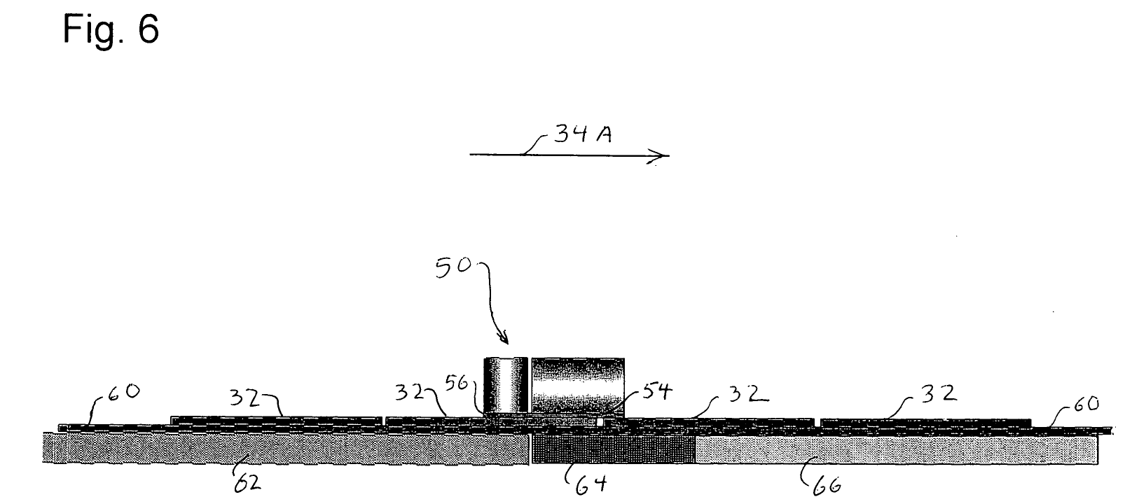

In the embodiments of the invention shown in FIG. 5 and FIG. 6, the mold plate is heated above the solder melting point from a heating zone preceding the IMCSS head. As FIG. 5 shows, first the hot dispensing zone injects solder under pressure into the cavities through a solder slot. Solidification occurs as follows. After the hot zone of the IMCSS head fills a row of cavities, a cooling zone immediately follows that lowers the temperature of both the solder in the cavity and the surrounding glass to below the melting point.

FIG. 5A illustrates a variation of the embodiment of the invention illustrated in FIG. 5, which may be used in the other embodiments of the invention as well. The head 50A of FIG. 5A is similar in its construction to that of head 50 of FIG. 5. Like numerals, having the suffix “A” are used to represent like parts, the function and operation of which have been described with respect to FIG. 5, and will not be repeated. However, head 50A includes an internal manifold 55 that distributes molten solder 28 from reservoir 51A to a series of three solder injection slots 26A, 26B and 26C of the type described above with respect to slot 26 of FIG. 5. The reason for the extra slots, which are preferably parallel to one another and spaced from one another by a distance of several times the width of the slots, is to assure complete filling of cavities 30. Specifically, although almost all cavities 30 are completely and adequately filled with solder by being traversed by just one slot, if complete filing of a cavity 30 with solder is not accomplished by the traversal of slot 26A over that cavity, then any remaining unfilled volume is filled with solder due to the traversal of slot 26B. After traversal by this second slot, the chances of still having unfilled volume are thus extremely small. However, if there still is any unfilled volume in any of the cavities 30, the traversal of slot 26C over those cavities will fill that remaining volume. After traversal by all three slots, the probability of having any cavity not being completely filled with solder very closely approaches zero.

Referring to FIG. 6, in a production environment, the mold plates 32 are generally supported in series on a moving transport belt 60, which moves over a support surface. The support surface may include a belt heating zone 62, a rapid cooling zone 64, and a residual cooling zone 66 below the transport belt 60. FIG. 6 Transport belt 60 is thin and made of a material that has reasonably good thermal conductivity, such as metal or other appropriate flexible material. Thus the solder begins to solidify as shown in the middle cavity of FIG. 5. The cooling zone typically extends over several rows of cavities, with the first row still molten and the last row completely solid. Thus as each last row exits the back of the cooling zone of the IMCSS head 50, the trailing edge of the head cannot in any way affect the solder in the cavity since the solder is by then solid metal.

In FIG. 6, the stationary head 50 and the heating and cooling zones below the transport belt 60 coincide, the head 50 producing its thermal effect from above the mold plates and the heating and cooling zones from below. In FIG. 6, other than the molten solder, the only items that move are the mold plates 32 and the transport belt 60 that moves them. The belt speed in this embodiment corresponds to the scan speed of the mold plates below the stationary IMCSS head 50.

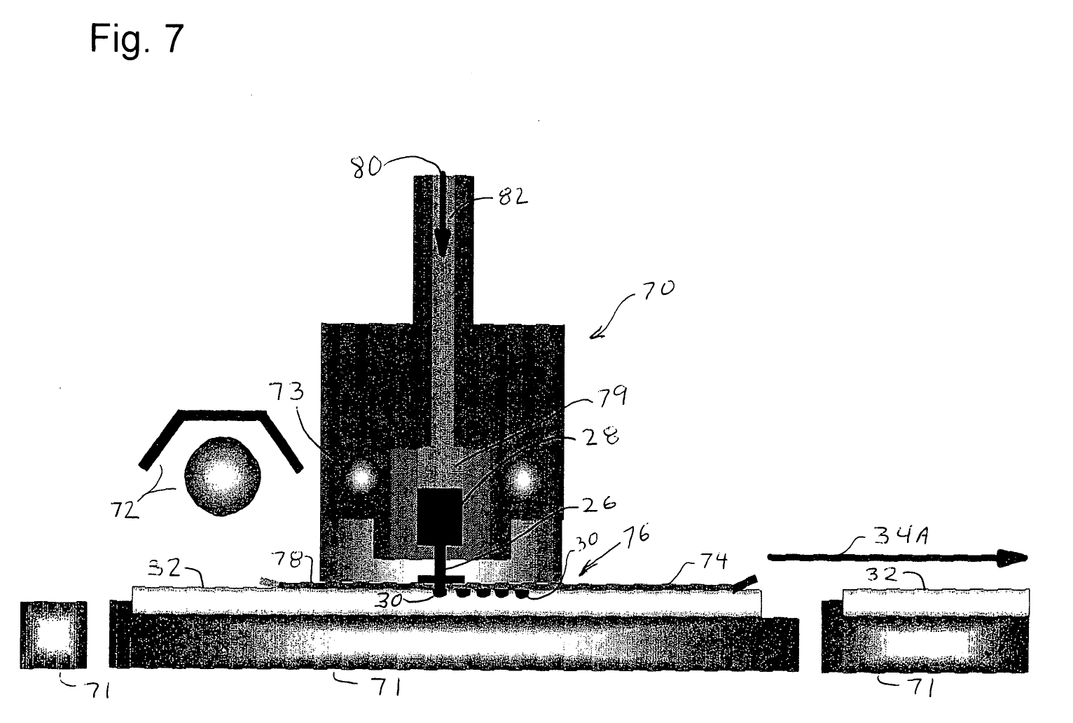

In another embodiment, as shown in FIG. 7, the mold plate 32 itself is also heated from below, but only to a temperature below the melting point of the solder, for example, 20° C. below the melting point. A hot plate 71 at this temperature may be used. Thus, to preheat the mold plates 32 above the melting point, which is required for proper solder distribution and injection through the slot 26 in the head 70, an infrared (IR) heater 72 is positioned in front of the head 70. This heater has a wavelength tuned to the maximum absorption frequency of the material of the mold plate 32, which is typically a glass, such as borosilicate glass, that is matched in coefficient of thermal expansion to that of silicon. This IR heater 72 quickly boosts the temperature of the mold plate from slightly below the melting point to slightly above. Once mold plates 32 are preheated, they pass under the IMCSS head 70, which typically includes a cartridge heater 73 to keep the solder 28 molten and to maintain the mold plate temperature above the melting point, but only over the solder injection zone. As in the previous embodiment, a cooling zone 74 of the contact plate 76 of the IMCSS head 50 follows after the heating zone 78. Thus the mold plates 32 immediately begin to cool after the point of solder injection. Since the heating to above the solder melting point is only a result of the IMCSS head 70 in this embodiment, once mold plates 32 pass into the cooling zone 74, they drop quickly to the temperature of the hot plate 71 below the mold plate 32. Thus solidification takes place while the filled cavities are constrained as before, but by the use of different means.

In the embodiment shown in FIG. 7, the motion of the mold plate 32 underneath the IMCSS head 70 is accomplished by the hot plate 71 itself moving laterally at the desired scan speed. Once the entire mold plate has been filled, the hot plate drops away leaving the mold plate supported by edge rails (not shown) As FIG. 7 shows, there are actually several hot plates 71 that move laterally, drop away, return to the start position, and raise laterally to receive each new mold plate 32 from its position on the edge rails. Thus, the hot plates travel in an endless loop. Mechanical arrangements to accomplish such motion are well known in the art.

FIG. 7 also illustrates, as is the case for all of the embodiments of the invention described herein, that a solder reservoir 79 within head 70 may be pressurized by a conduit of pressurized, relatively chemically non-reactive gas, such as nitrogen, as represented by arrow 80, conducted to reservoir 79 by a conduit, such as a hose 82.

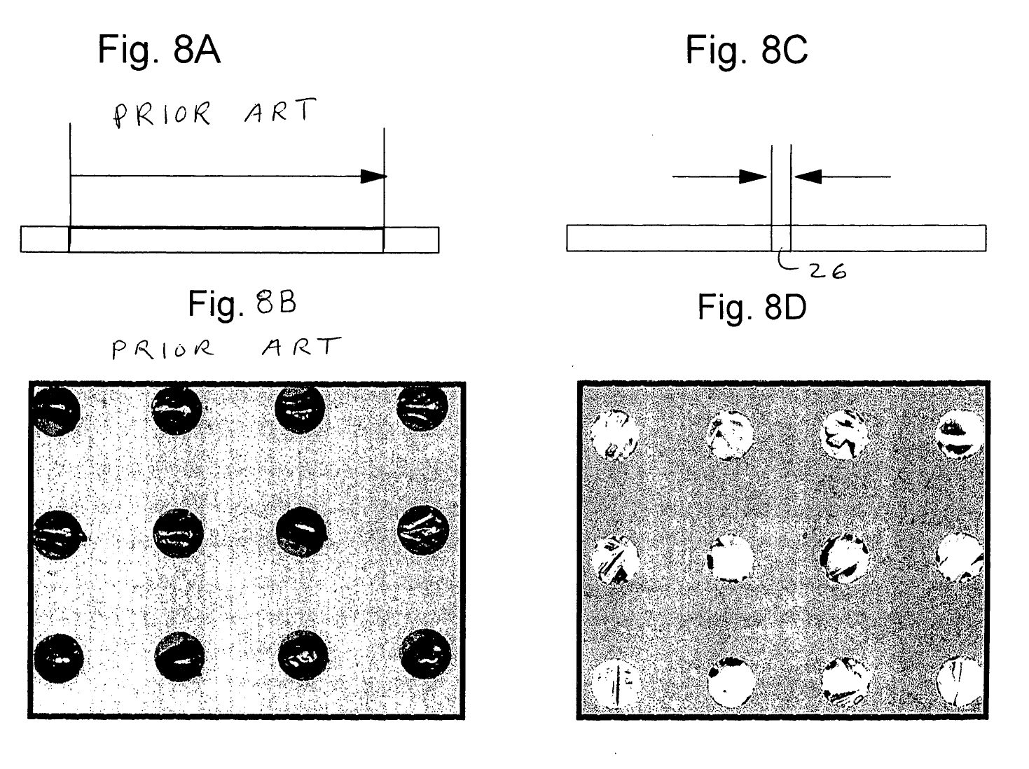

FIG. 8A to FIG. 8D illustrate another important novel component of this invention. The slot which is wide enough to cover the entire diameter of an 8″ or 12″ wafer is supplied by a heated solder reservoir, which is pressurized to initiate solder feed to the slot. Although not drawn to scale, one important novel feature of the new IMCSS head is the solder slot itself. As illustrated in FIG. 8A, in the prior art these slots were between 0.040 inch (1.02 mm) to 0.080 inch (2.03 mm) wide by 8 inches (20.3 cm) to 12 inches (30.5 cm) long. The relatively poor results of using such a wide slot are illustrated in FIG. 8B.

As illustrated in FIG. 8C, the new slots are much narrower. While of the same length, these slots may be only 0.0005 inch (0.013 mm) to 0.010 inch (0.25 mm) in width. Thus, if the cavities in FIG. 8D are 0.005 inch (0.13 mm) in diameter, the slot in FIG. 8C may be as narrow as 0.0005 inch (0.013 mm); at least four to eighty times as narrow as previously used slots. This results in much better fill uniformity. Previously, slots were so wide that they may have covered several rows of cavities at once. Over such a large injection area typical fill pressures may have been insufficient to overcome surface tension induced solder scavenging from cavities as they left the fill slot area. This left incompletely filled cavities as seen in FIG. 8B. Also, reduced solder volumes in the cavities make them more prone to surface contour irregularities as shown.

The new very narrow slot design of the present invention assures that for the same reservoir pressure, pressures per unit area in the slot are sufficient to prevent surface tension induced fill non-uniformities, as illustrated in FIG. 8D. Fill pressures on narrow slots are greater than surface tension effects and thus assure reasonably level solder surface contours even prior to solidification. However, solidification is still required to enable very low oxygen levels to be used without ball-up, as described previously.

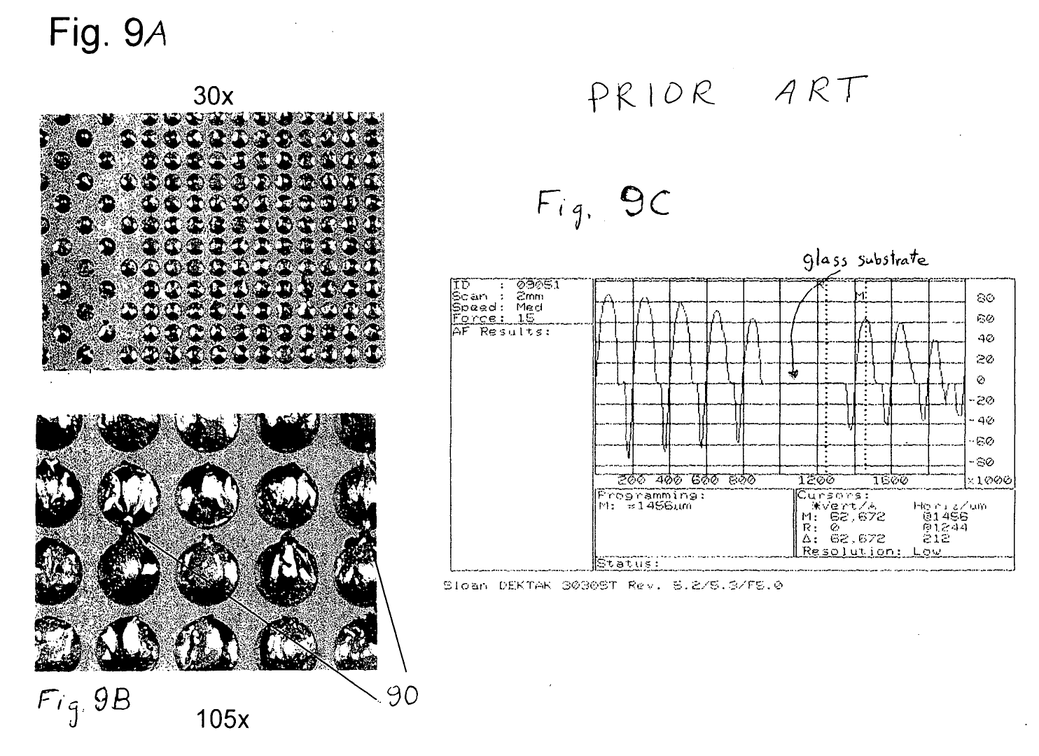

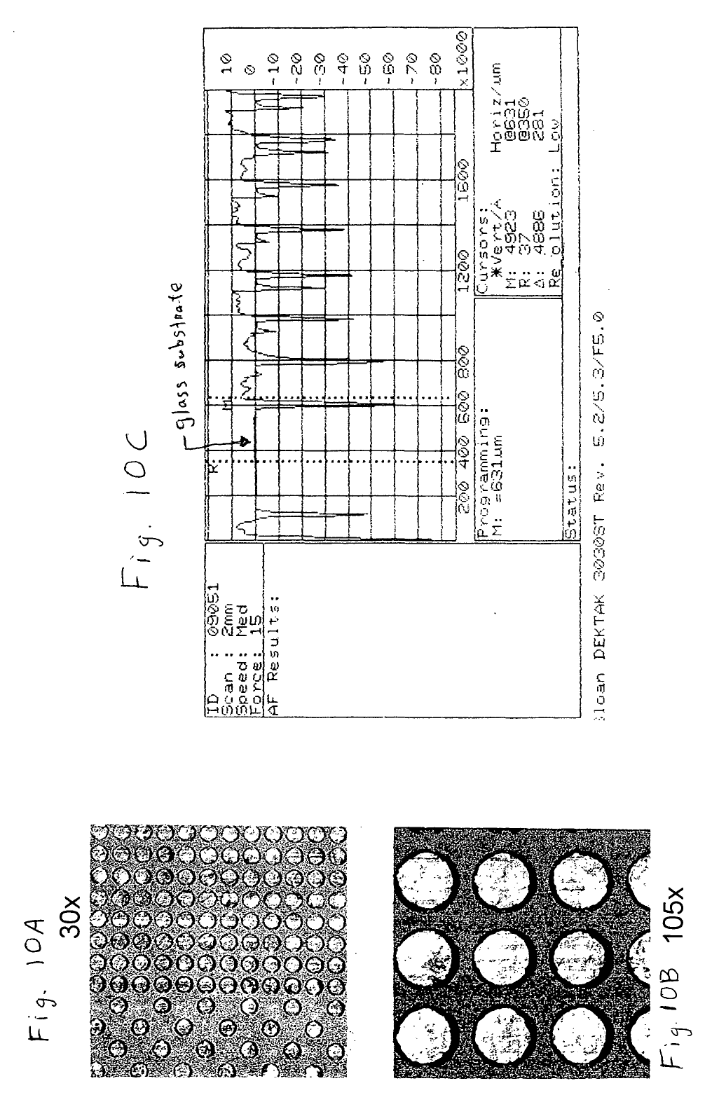

FIGS. 9A, 9B and 9C show photographic and measured evidence of some of the problems with the previous IMS process. As FIG. 9A and FIG. 9B reveal, significant solder crowning is evident on all filled cavities. The measurement FIG. 9C shows this crown height to be six microns or more above the top surface of the mold plate. Additionally, FIG. 9A and FIG. 9B show several locations 90 where actual solder bridging between adjacent cavities has occurred. All these are unacceptable problems that interfere with the transfer step in the IMS wafer bumping process, as described previously. The solder used was a ternary Pb-free SnAgCu alloy.

FIG. 10A, FIG. 10B and FIG. 10C show the vast improvement in results using the IMCSS process of the present invention. FIG. 10A and FIG. 10B reveal completely filled, flat topped solder in cavities with no bridging and clean glass surfaces between adjacent cavity walls. The measurement of FIG. 10C shows that the same ternary Pb-free alloy now is less than one half micron above the top surface of the mold plate, thus no longer requiring the “shaving” step for solder oxide cleaning or removal of bridging.

The described new IMCSS process thus provides true manufacturing capabilities for wafer bumping by these novel means. With this significant improvement in the IMS wafer bumping process, the goal of providing high-end bumping capabilities (similar to plating) at low-end costs (similar to paste screening) is achieved. There is no other known wafer bumping process that provides this potent combination.

By the term “traverses said substrate”, it is meant that there is relative motion between the die of the head and the substrate. As shown above, this may be accomplished by moving the head over a stationary substrate, using any conventional drive mechanism, such as, for example, a worm gear which engages a threaded block to which the head is mounted. It may also be accomplished by moving the substrates, as illustrated in FIG. 6 and FIG. 7 by using a moving belt or hot plates to carry the substrates. An arrangement where both the substrate and the head move may also be possible. In any event, there is relative motion between the head and the substrate.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments have been provided as an example and not as a limitation. The scope of the invention is defined by the appended claims.

1. A method for filling solder in a multiplicity of cavities on the surface of a substrate, comprising:
providing a stream of molten solder through a slot opening in a die that traverses said substrate so as to place successive ones of said multiplicity of cavities in intimate contact with said slot opening, said contact being such that the molten solder in the stream exerts a pressure against the surface of the substrate so as to fill the multiplicity of cavities with molten solder, and
successively solidifying said molten solder in said cavities immediately after said cavities are filled with solder while the solder is constrained by said die.

2. A method as recited in claim 1, wherein said solidifying is performed by successively cooling said solder in said cavities.

3. A method as recited in claim 2, wherein said cooling is performed by using a cooled solidification zone immediately following the die.

4. A method as recited in claim 1, wherein said substrate is that of a bump solder mold.

5. A method as recited in claim 1, wherein said substrate is that of a semiconductor device.

6. A method as recited in claim 1, wherein said substrate is that of an electrical interconnection device.

7. A method as recited in claim 1, conducted in an atmosphere having an oxygen concentration of between one and two percent by volume.

8. A method as recited in claim 1, conducted in an atmosphere having an oxygen concentration of less than one percent by volume.

9. A method as recited in claim 1, wherein a plurality of said substrate are mounted on a moving belt, and wherein said head is scanned with respect to said substrates due to motion of said belt.

10. A method as recited in claim 9, wherein in a position on an opposite side of said belt from said substrates and said head a heating zone, a rapid cooling region, and a residual cooling region, the method comprising moving said substrates through said heating zone, said rapid cooling region, and said residual cooling region.

11. A method as recited in claim 1, further comprising:
placing the substrate on a hot plate heated to below the melting point of the solder;
heating the substrate to a temperature greater than that of the melting point of the solder;
moving the hot plate so that the surface of the substrate is scanned by the head; and
withdrawing the hot plate from the head.

12. A method as recited in claim 11, wherein the heating of the substrate and the moving are performed simultaneously.

13. A method as recited in claim 11, wherein successive hot plates traveling in an endless loop carry successive substrates to be scanned by said head.

14. A method as recited in claim 11, wherein radiative heating is used for heating the substrate to a temperature greater than that of the melting point of the solder.

15. A method as recited in claim 1, wherein the solder is applied through a slot having a width of 0.0125 mm to 0.25 mm.

16. A method as recited in claim 1, wherein the solder is applied through a slot having a length to width ratio between 24,000 to 1 and 1,000 to 1.

17. A method as recited in claim 1, further comprising:
providing additional molten solder through at least one additional slot opening in said die, to fill any unfilled regions of said cavities.

18. A method as recited in claim 17, wherein said at least one additional slot consists of two additional slots.

19. A method for filling solder in a multiplicity of cavities on the surface of a substrate, comprising:
providing a stream of molten solder through a slot opening in a die, that traverses said substrate so as to place successive ones of said multiplicity of cavities in intimate contact with said slot opening, said contact being such that the molten solder in the stream exerts a pressure against the surface of the substrate so as to fill the multiplicity of cavities with molten solder, and
solidifying said molten solder in said cavities:
wherein said slot opening has a width of between 0.0125 mm and 0.25 mm.

20. A method as recited in claim 19, wherein the a slot has a length to width ratio between 24,000 to 1 and 1,000 to 1.

21. An apparatus for filling solder in a multiplicity of cavities on the surface of a substrate, comprising:
a source of a stream of molten solder;
a die having a slot opening through which said molten solder flows;
an arrangement for causing relative motion between said substrate and said die so that said die traverses said substrate so as to place successive ones of said multiplicity of cavities in intimate contact with said slot opening, said contact being such that the molten solder in the stream exerts a pressure against the surface of the substrate so as to fill the multiplicity of cavities with molten solder; and
a cooling portion associated with said die and positioned to successively solidifying said molten solder in said cavities immediately after said cavities are filled with solder while constrained by said die.

22. An apparatus as recited in claim 21, wherein said cooling portion is a cooled solidification zone positioned so as to immediately follow the die in contacting and vertically constraining solder in said openings.

23. An apparatus as recited in claim 21, configured to receive as said substrate, a bump solder mold.

24. An apparatus as recited in claim 21, configured to receive as said substrate, a semiconductor device.

25. An apparatus as recited in claim 21, configured to receive as said substrate an electrical interconnection device.

26. An apparatus as recited in claim 21, further comprising an atmosphere control portion for providing a controlled atmosphere in which said filling of said cavities occurs.

27. An apparatus as recited in claim 26, wherein said atmosphere control portion provides an atmosphere having an oxygen concentration of between one and two percent by volume.

28. An apparatus as recited in claim 26, wherein said atmosphere control portion provides an atmosphere having an oxygen concentration of less than one percent by volume.

29. An apparatus as recited in claim 21, further comprising a moving belt for receiving a plurality of said substrate, and wherein said head is scanned with respect to said substrates due to motion of said belt.

30. An apparatus as recited in claim 29, further comprising:
a heating zone, a rapid cooling region, and a residual cooling region in a position on an opposite side of said belt from said substrates and said head, so that said substrates are moved through said heating zone, said rapid cooling region, and said residual cooling region.

31. An apparatus as recited in claim 30, wherein the heating zone is aligned with said die, and the rapid cooling region is aligned with said cooling portion on opposite sides of said belt.

32. An apparatus as recited in claim 21, further comprising:
a hot plate heated to below the melting point of the solder for receiving the substrate;
a heater for heating the substrate to a temperature greater than that of the melting point of the solder;
an arrangement for moving the hot plate so that the surface of the substrate is scanned by the head; and for then withdrawing the hot plate from the head.

33. An apparatus as recited in claim 32, wherein the heating of the substrate and the moving are performed simultaneously.

34. An apparatus as recited in claim 32, further comprising an arrangement for causing said hot plates to travel in an endless loop to carry successive substrates to be scanned by said head.

35. An apparatus as recited in claim 32, further comprising a radiative heater for heating the substrate to a temperature greater than that of the melting point of the solder.

36. An apparatus as recited in claim 21, wherein the slot has a width of 0.0125 mm to 0.25 mm.

37. An apparatus as recited in claim 21, wherein the slot has a length to width ratio between 24,000 to 1 and 1,000 to 1.

38. An apparatus as recited in claim 21, further comprising at least one additional slot opening in said die, for providing additional molten solder to fill any unfilled regions of said cavities.

39. An apparatus as recited in claim 38, wherein said at least one additional slot consists of two additional slots.

40. An apparatus for filling solder in a multiplicity of cavities on the surface of a substrate, comprising:
a source of a stream of molten solder;
a die having a slot opening through which said molten solder flows;
an arrangement for causing relative motion between said substrate and said die so that said die traverses said substrate so as to place successive ones of said multiplicity of cavities in intimate contact with said slot opening, said contact being such that the molten solder in the stream exerts a pressure against the surface of the substrate so as to fill the multiplicity of cavities with molten solder; and
wherein said slot opening has a width of between 0.0125 mm and 0.25 mm.

41. A method as recited in claim 40, wherein the a slot has a length to width ratio between 24,000 to 1 and 1,000 to 1.

42. An article of manufacture comprising:
a substrate having cavities on a surface, said cavities being filled with solidified solder; and said solder solidified in each cavity in a direction parallel to said surface.

43. An article as recited in claim 42, wherein said solder is constrained at said surface as the solder solidified.
